(19) United States
(12) Patent Application Publication
(10) Pub. No.: US 2010/0268948 A1
(43) Pub. Date: Oct. 21, 2010

(54) RECORDING DEVICE AND CONTENT-DATA DISTRIBUTION SYSTEM

(75) Inventors: Shinichi MATSUKAWA, Suginami-ku (JP); Taku Kato, Kamakura-shi (JP); Akihiro Kasahara, Sanbu-gun (JP); Hiroshi Suu, Chigasaki-shi (JP); Akira Miura, Sagamihara-shi (JP); Atsushi Kondo, Yokohama-shi (JP); Hiroyuki Sakamoto, Ome-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/711,570

(22) Filed: Feb. 24, 2010

(30) Foreign Application Priority Data
Apr. 16, 2009 (JP) 2009-099868
Aug. 7, 2009 (JP) 2009-184171

(51) Int. Cl. H04L 9/32; G06F 12/14

(52) U.S. Cl. 713/168; 713/193

(57) ABSTRACT

A recording device comprises a memory unit configured to be communicationable with an external device and to record key data for encryption of content data through an authentication process, and a controller which controls the memory unit. The memory unit comprises a normal recording unit which is accessible from the exterior through the controller without an authentication process, a protected recording unit which is accessible from the external device when authentication of a first authentication process completes, and a writing restricted/protected recording unit which is accessible from the external device when authentication of a second authentication completes and is unwritable and unaccessible from the external device when authentication of only the first authentication process completes.

### CROSS-REFERENCE TO RELATED APPLICATIONS

This application is based upon and claims the benefit of priority from the prior Japanese Patent Application No. 2009-99868, filed on Apr. 16, 2009, and the prior Japanese Patent Application No. 2009-184171, filed on Aug. 7, 2009, the entire contents of which are incorporated herein by reference.

### BACKGROUND OF THE INVENTION

1. Field of the Invention

The present invention relates to a recording device which is applicable to a content-data playback system and which stores content data in an encrypted manner.

2. Description of the Related Art

Recently, content-distributing systems which distribute computerized content, such as books, newspapers, music, or motion pictures, to user terminals to allow users to view such content become widespread in accordance with the development of information societies.

However, computerized content (hereinafter, simply called “content”) can be easily replicated, so that misconduct disregarding copyrights thereof is likely to happen. In general, from the standpoint of protecting content against such misconduct, content is recorded in an encrypted manner by an encryption key, and decrypted when reproduced. An example of such kind of content protection technologies is CPRM (Content Protection for Recordable Media). Moreover, there is proposed an encryption double-key scheme that uses two kinds of keys to doubly encrypt content (see, for example, JP2005-341156A). This kind of encryption double-key scheme is used in, for example, MQbic (a registered trademark). In encryption keys, a key unique to a recording medium (recording device), e.g., a medium-unique key is stored securely in a secret area in the recording medium, and is not externally-accessible at all. Therefore, even if, for example, an encryption-content-key data is solely copied fraudulently, a person who fraudulently copied that data cannot utilize content data without the medium-unique key.

There are various forms of content data encrypted and stored in a recording medium in this fashion including ones which are provided from paid sites on the Internet or store terminals on the basis of payment of compensation. In contrast, there are another kind of content data distributed through, for example, terrestrial digital broadcasting at no charge. Regardless of requisition of payment or free, the protection of copyrights must be guaranteed, but in general, the level of the need of protection for content data distributed with charge is higher than that for content data without charge. Moreover, charged data has different levels of the need of protection depending on the amount of charge. Furthermore, the need of protection for content data created by a user himself/herself is less than that for content data distributed with charge.

According to conventional content-data distribution systems, regardless of the level of the need of protection, content data is stored in a recording medium using the same key data in the same memory scheme. Therefore, it is hard to say that an existing systems employ protection scheme in accordance with the level of the need of protection employed.

### SUMMARY OF THE INVENTION

A recording device according to a first aspect of the present invention comprises a memory unit which is configured to be communicationable with an external device through an authentication process and to record key data for encryption of content data, and a controller which controls the memory unit. The memory unit comprises a normal recording unit which is externally accessible through the controller without an authentication process, a protected recording unit which is accessible from the external device when authentication of a first authentication process completes, and a writing restricted/protected recording unit which is accessible from the external device when authentication of a second authentication process completes, and is unwritable and unaccessible from the external device when authentication of only the first authentication process completes.

A content-data distribution system according to a second aspect of the present invention comprises a server which distributes encrypted content data, and a recording device which stores the encrypted content data. The server and the recording device each comprise an authentication unit each executing a first authentication process and a second authentication processes. The recording device further comprises a memory unit which is configured to be communicationable with the server through the first and the second authentication processes and to record key data for encryption of content data, and a controller which controls the memory unit. The memory unit includes a normal recording unit which is accessible from the server through the controller without an authentication process, a protected recording unit which is accessible from the server when authentication of the first authentication process completes, and a writing restricted/protected recording unit which is accessible from the server when authentication of the second authentication process completes and is unwritable and unaccessible from the server when authentication of only the first authentication process completes.

A content-data distribution system according to a third aspect of the present invention comprises a recording/playback device which distributes encrypted first content data, and a recording device which stores the encrypted first content data and second content data distributed from an external device. The recording/playback device and the recording device each comprise an authentication unit each executing a first authentication process. The authentication unit of the recording device further executes a second authentication process. The recording device comprises a memory unit which is configured to be communicationable with the recording/playback device and the external device through the first and the second authentication processes, and to record key data for encryption of the first and the second content data, and a controller which controls the memory unit. The memory includes a normal recording unit which is accessible from the recording/playback device and the external device through the controller without an authentication process, a protected recording unit which is accessible from the recording/playback device and the external device when authentication of the first authentication process completes, and a writing restricted/protected recording unit which is accessible from the external device when authentication of the second authentication process completes and is unwritable and unaccessible from the recording/playback device and the external device when authentication of only the first authentication process completes.

### BRIEF DESCRIPTION OF THE DRAWINGS

FIG. 1 shows an overall configuration of a content-data distribution system associated with a recording device according to an embodiment of the present invention;

FIG. 2 shows an example operation of writing-in distributed content data from a content server 20 to a memory card 10;

FIG. 3 shows an example operation of writing-in distributed content data from a user recording/playback device 30 to the memory card 10;

FIG. 4 shows an example operation of requesting read-out of distributed content data from the user recording/playback device 30 to the memory card 10.

### DETAILED DESCRIPTION OF THE EMBODIMENT

An embodiment of the present invention will be explained in detail with reference to the accompanying drawings.

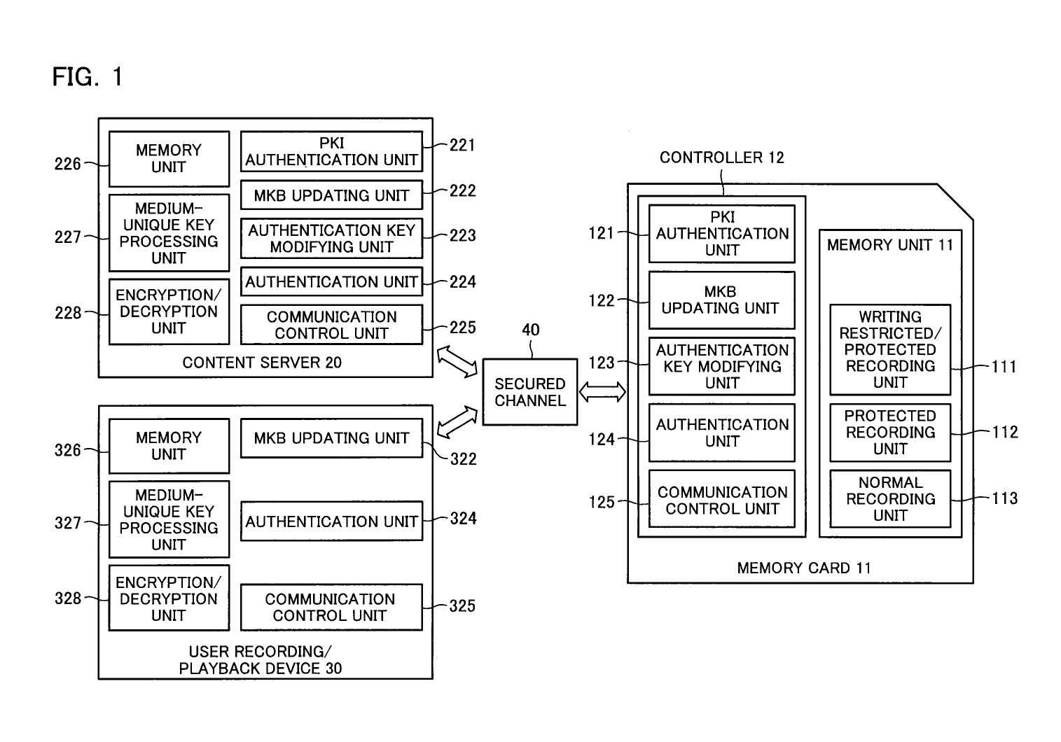

FIG. 1 shows an overall configuration of a content-data distribution system associated with a recording device according to an embodiment of the present invention. The system comprises a memory card 10 as a recording device, a content server 20 as a host device which is an external device supplying content data to the memory card 10, and a user recording/playback device 30 as a host device which is an external device connected to the memory card 10, and having functions of playback content data and of writing locally-possessed content data in the memory card 10. The content server 20 is an example of devices which enable writing of content data for distribution (hereinafter, “distributed content-data”) into the memory card 10 only when authentication succeeds, i.e., when a strict authentication process is completed. Moreover, the user recording/playback device 30 is an example of devices which enable writing of content data into the memory card 10 when authentication through a simpler authentication process than the foregoing authentication process succeeds and completes. Furthermore, the memory card 10 as a recording device can be in various card-like forms, or can be other kinds of recording media equipped with a controller. Content data possessed by the user recording/playback device 30 has a lower level of protection needs in comparison with the distributed content data distributed from the content server 20. For example, it is such as recorded data of a terrestrial digital broadcasting, or data created and recorded by a user himself/herself (hereinafter, generically called “self-recorded content data”).

The memory card 10 has functions of storing content data possessed by the content server 20 or the user recording/playback device 30 in an encrypted manner after executing a predetermined authentication process therewith, and conversely, of decrypting encrypted content data possessed locally to supply the decrypted data to the user recording/playback device 30.

The memory card 10 comprises a memory unit 11 which stores data, and a controller 12 which controls the memory unit 11.

The memory unit 11 comprises, as an example, a plurality of recording units 111 to 113 independent from one another for storing various data. A writing restricted/protected recording unit 111 becomes writable of data when a particular authentication process (a second authentication process) completes, and is unwritable and unaccessible even if other authentication processes complete.

A protected recording unit 112 becomes accessible when a simpler authentication process (a first authentication process) than the foregoing particular authentication process (the second authentication process) completes. A normal recording unit 113 is freely accessible from the exterior regardless of authentication processes. Note that the memory card 11 stores a medium certificate Cm which indicates the validity of the memory card 10, a medium secret key Kmsecret, a medium ID, an MKB (Media Key Block), a medium device key Kdm and the like in a non-illustrated system area. The MKB is a collection of encrypted medium keys. Each of medium keys is used as a base key for encryption of content data, and encrypted with device keys Kd provided in the content server 20 and the user recording/playback device 30 as secret keys. The MKB also records information on fraudulent devices, and fraudulent devices cannot take out the medium key from the MKB.

Moreover, the controller 12 comprises, as an example, a PKI authentication unit 121, an MKB updating unit 122, an authentication key modifying unit 123, an authentication unit 124, and a communication control unit 125. The PKI authentication unit 121 has functions of executing a PKI authentication process with another device on the other side of the communication path, and of issuing a session key Ks1 as a result. The MKB updating unit 122 has functions of updating the MKB (Media Key Block) stored in the memory unit 11, and of generating a first authentication key Kauth1 in accordance with the process result. Furthermore, the authentication key modifying unit 123 has a function of converting the first authentication key Kauth1 based on the session key Ks1 to generate a second authentication key Kauth2.

The authentication unit 124 generates a session key Ks or Ks′ in accordance with the foregoing first authentication key Kauth1 or the second authentication key Kauth2. The communication control unit 125 establishes a secured channel 40 in accordance with the session key Ks or Ks′, and executes a secured communication.

The content server 20 is a data-distribution server which executes a strict authentication including both of the other PKI authentication and the MKB authentication through store terminals provided at, for example, convenience stores, and distributes content data to the memory card 10 or a user terminal cooperated therewith. Upon completion of the strict authentication, the content server 20 writes distributed content data in the memory card 10.

The content server 20 comprises a PKI authentication unit 221, an MKB updating unit 222, an authentication-key modifying unit 223, an authentication unit 224, a communication control unit 225, a memory unit 226, a medium-unique key processing unit 227, and an encryption/decryption unit 228. The PKI authentication unit 221, the MKB updating unit 222, the authentication-key modifying unit 223, the authentication unit 224, and the communication control unit 225 have the same configurations and the same functions as those of the foregoing PKI authentication unit 121, the MKB updating unit 122, the authentication-key modifying unit 123, the authentication unit 124, and the communication control unit 125, respectively. The memory unit 226 stores a server certificate Cs which indicates the validity of the content server 20, a server secret key Kssecret, the MKB, a server device key Kds and the like. The medium-unique key processing unit 227 is a unit executing a process of generating a medium-unique key Kmu in accordance with MKB updating process. Moreover, the encryption/decryption unit 228 has functions of decrypting received encrypted data, and of encrypting data possessed by itself.

Furthermore, the user recording/playback device 30 is, for example, a portable audio player or a portable one-segment broadcasting TV receiver owned by a user. It is connected to the memory card 10, and has functions of utilizing (viewing/playback) content data stored in the memory card 10, or of writing content data (self-recorded content data) possessed locally in the memory card 10 after an authentication process therewith completes. The authentication process of the user recording/playback device 30 is a simple authentication including the MKB authentication process only.

The user recording/playback device 30 comprises an MKB updating unit 322, an authentication unit 324, a communication control unit 325, a memory unit 326, a medium-unique key processing unit 327, and an encryption/decryption unit 328. These units have substantially the same functions as those of the MKB updating unit 222, the authentication unit 224, the communication control unit 225, the memory unit 226, the medium-unique key processing unit 227, and the encryption/decryption unit 228, respectively. The user recording/playback device 30 has no functions corresponding to the PKI authentication unit 221 and the authentication key modifying unit 223, and is configured to execute a simple authentication process including the MKB authentication process only.

Because of such a configuration, according to the system of the embodiment, content data is written in either the recording unit 111 or 112 of the memory card 10 in accordance with the level of an authentication process to be executed. A device which has completed the strict authentication process (an authentication process which is a combination of the PKI and the MKB in the embodiment), e.g., the content server 20, can store distributed content data in the writing restricted/protected recording unit 111.

In contrast, a device which has completed a simple authentication process (an authentication process executed solely by the MKB in the embodiment), e.g., the user recording/playback device 30, is allowed to store self-recorded content data possessed locally in the protected recording unit 112 only, and cannot store such data in the writing restricted/protected recording unit 111.

According to such operation, the memory card 10 can store content data having a high level of protection needs, e.g., distributed content data in the writing restricted/protected recording unit 111. In contrast, it stores content data having a low level of protection needs, e.g., self-recorded content data, in the protected recording unit 112 which has no writing restriction. That is, it is possible to distinguishingly write content data in different storing areas in accordance with the level of protection needs, so that copyright management is facilitated. As a result, it serves to inhibit any fraudulent replication of content data.

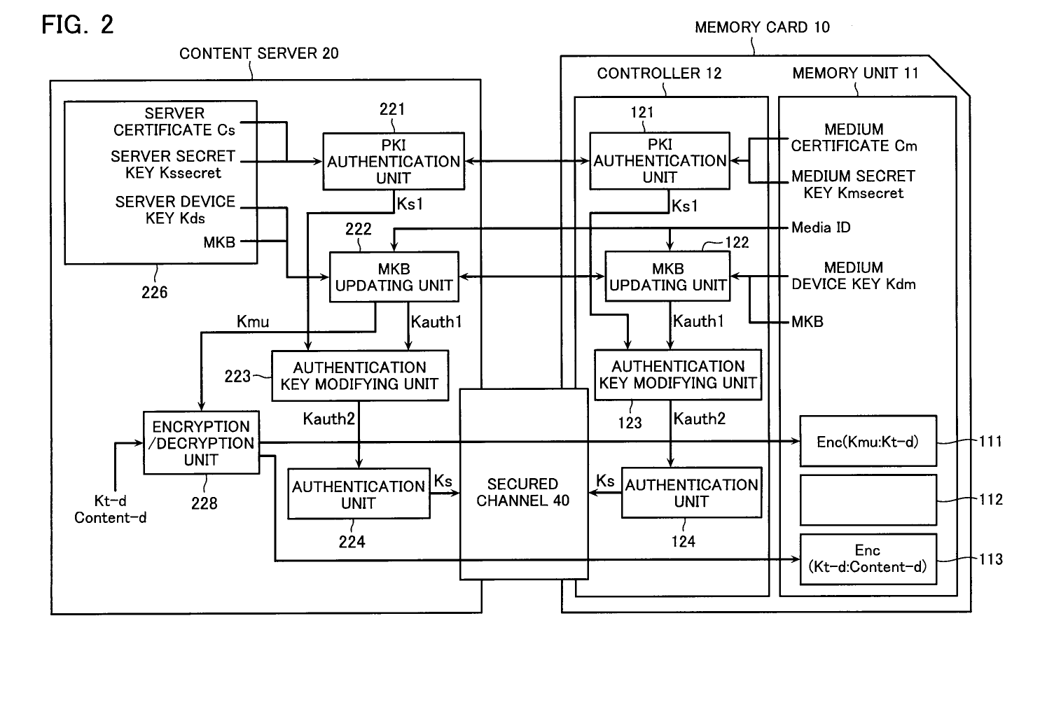

FIG. 2 shows an example operation of writing distributed content data from the content server 20 into the memory card 10.

First, the PKI authentication units 121 and 221 execute a PKI authentication process. The PKI authentication is executed with the medium certificate Cm and the medium secret key Kmsecret both possessed by the memory unit 11, as well as the server certification Cs and the server secret key Ks secret both possessed by the memory unit 226, and the session key Ks1 is generated as a result.

Next, the MKB updating units 122 and 222 execute the MKB authentication process. The MKB and the medium device key Kdm are input from the memory unit 11 of the memory card 10 into the MKB updating unit 122 and a medium key is generated. Also, the MKB and the server device key Kds are input from the memory unit 226 of the content server 20 into the MKB updating unit 222 and a medium key is generated. Then, the first authentication key Kauth1 is generated upon confirmation of matching of these medium. Moreover, the MKB updating unit 222 of the content server 20 generates the medium-unique key Kmu.

The authentication key modifying unit 123, and the authentication key modifying unit 223 generate the second authentication key Kauth2 based on the first authentication key Kauth1 and the session key Ks1. The authentication units 124 and 224 establish the secured channel 40 in accordance with the second authentication key Kauth2, and enable the content server 20 to write data in the memory card 10. That is, content data Content-d subjected to writing is encrypted with a title key Kt-d and stored in the normal recording unit 14, and the title key Kt-d thereof is encrypted with the medium-unique key Kmu and becomes an encrypted title key Enc(Kmu:Kt-d), and is stored in the writing restricted/protected recording unit 111.

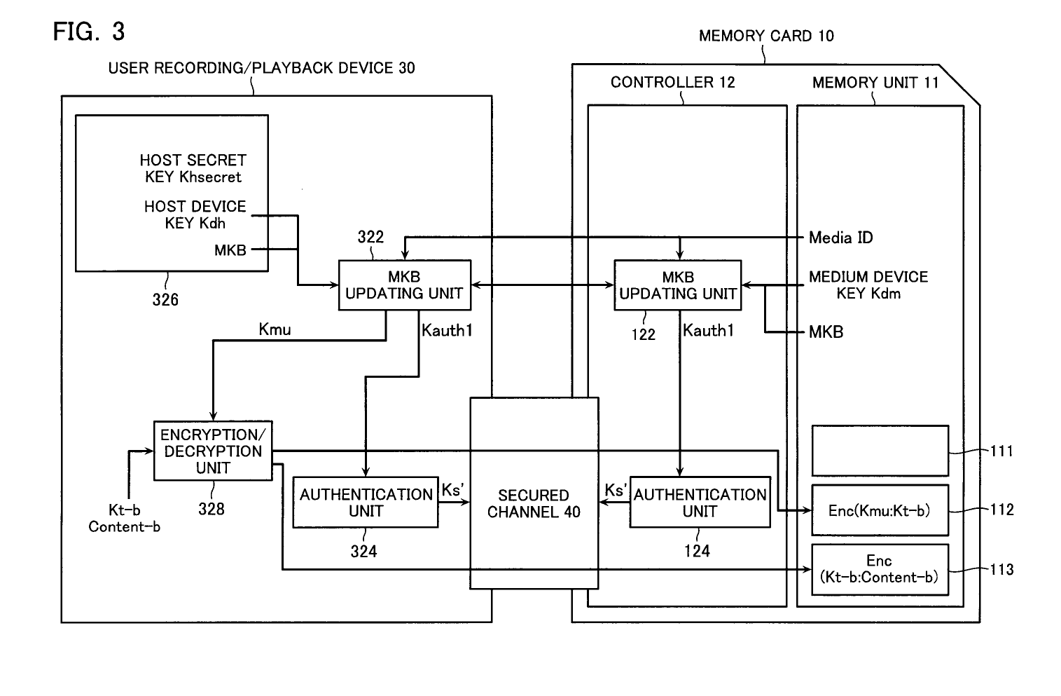

Next, an operation of writing data into the memory card 10 using the user recording/playback device 30 will be explained with reference to FIG. 3. Unlike the content server 20, the user recording/playback device 30 has no PKI authentication unit, so that the authentication process is executed based on the MKB authentication process only. That is, the MKB updating units 122 and 332 execute the MKB authentication process. The MKB and the medium device key Kdm are input from the memory unit 11 into the MKB updating unit 122 and a medium key is generated. Also, the MKB and a host device key Kdh are input from the memory unit 326 into the MKB updating unit 322 and a medium key is generated. Then, and the first authentication key Kauth1 is generated upon confirmation of matching of these medium keys. Moreover, the MKB updating unit 322 generates the medium-unique key Kmu.

The authentication units 124 and 324 establish the secured channel 40 in accordance with the first authentication key Kauth1, and enable the content server 20 to write data into the memory card 10. That is, the content data Content-b subjected to writing is encrypted with a title key Kt-b and stored in the normal recording unit 14, and the title key Kt-b thereof is encrypted with the medium-unique key Kmu so as to be an encrypted title key Enc(Kmu:Kt-b) and stored in the protected recording unit 13. As explained above, the authentication unit 124 changes a recording unit for writing data under a request of writing (an encrypted title key), in accordance with the difference of the authentication process which has been executed. This enables data subjected to writing to be distinguishingly written in the different recording units in accordance with the level of the need of protection. Accordingly, it becomes easy to manage content data at the memory card 10.

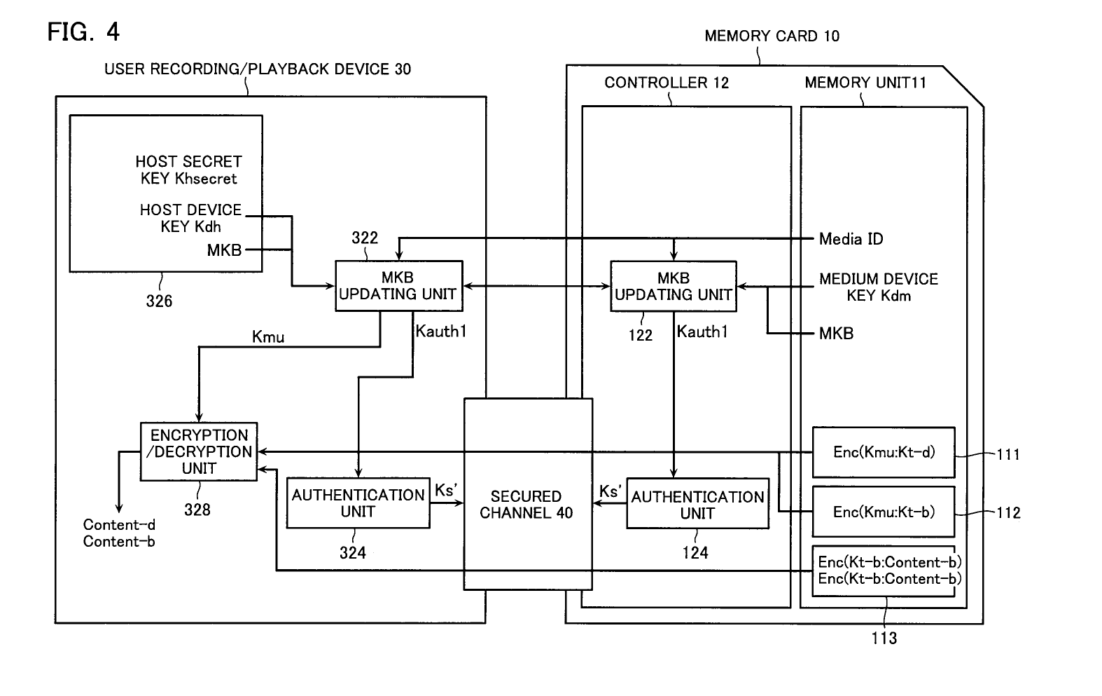

FIG. 4 shows an operation of reading-out data and of playback thereof at the user recording/playback device 30. In this case, reading-out of data from both of the writing restricted/protected recording unit 111 and the protected recording unit 112 are enabled, because of the secured channel 40 established by the authentication units 124 and 324 upon execution of the MKB authentication process in the same manner. Accordingly, the user recording/playback device 30 can reproduce distributed content data (second content data) written by the content server 20 in addition to self-recorded content data (first content data) written by the user recording/playback device 30 itself.

Although the embodiment of the present invention has been explained, the present invention is not limited to the embodiment, and can be changed and modified in various forms without departing from the scope and the spirit of the present invention.

What is claimed is:

1. A recording device comprising:
a memory unit configured to be communicationable with an external device through an authentication process and to record key data for encryption of content data, and a controller configured to control the memory unit, and
the memory unit comprising:
a normal recording unit configured to be externally accessible through the controller without an authentication process;
a protected recording unit configured to be accessible from the external device when authentication of a first authentication process completes; and
a writing restricted/protected recording unit configured to be accessible from the external device when authentication of a second authentication process completes, and to be unwritable and unaccessible from the external device when authentication of only the first authentication process completes.

2. The recording device according to claim 1, wherein
the first authentication process is executed with an MKB authentication process, and
the second authentication process is executed by a combination of a PKI authentication process and an MKB authentication process.

3. The recording device according to claim 1, wherein
the first authentication process is executed with a first authentication key which is generated through an MKB authentication process, and
the second authentication process is executed with a second authentication key which is generated by combining the first authentication key and a session key, the session key being generated through a PKI authentication process.

4. The recording device according to claim 3, further comprising an authentication unit configured to execute an authentication process based on the first authentication key or the second authentication key, and wherein
the authentication unit permits writing into the protected recording unit when the first authentication key is obtained, and permits writing into the writing restricted/protected recording unit when the second authentication key is obtained.

5. The recording device according to claim 1, wherein the controller allows the external device having completed the first authentication process to read out data from the writing restricted/protected recording unit and the protected recording unit.

6. The recording device according to claim 3, wherein
the memory unit stores an MKB, and
the controller includes an MKB updating unit configured to update the MKB and generate the first authentication key.

7. A content-data distribution system comprising:
a server configured to distribute encrypted content data; and
a recording device configured to store the encrypted content data, and
the server and the recording device each comprising an authentication unit configured to execute a first authentication process and a second authentication process,
the recording device comprising a memory unit configured to be communicationable with the server through the first and second authentication processes and to record key data for encryption of content data, and a controller configured to control the memory unit, and
the memory unit including:
a normal recording unit configured to be accessible from the server through the controller without an authentication process;
a protected recording unit configured to be accessible from the server when authentication of the first authentication process completes; and
a writing restricted/protected recording unit configured to be accessible from the server when authentication of the second authentication process completes and to be unwritable and unaccessible from the server when authentication of only the first authentication process completes.

8. The content-data distribution system according to claim 7, wherein
the first authentication process is executed with a first authentication key generated through an MKB authentication process, and
the second authentication process is executed with a second authentication key which is generated by combining the first authentication key and a session key, the session key being generated through a PKI authentication process.

9. The content-data distribution system according to claim 8, wherein
the respective authentication units of the server and the recording device execute an authentication process based on the first authentication key or the second authentication key, and
the authentication unit of the recording device permits writing into the protected recording unit when the first authentication key is obtained, and permits writing into the writing restricted/protected recording unit when the second authentication key is obtained.

10. The content-data distribution system according to claim 7, wherein the controller allows the server having completed the first authentication process to read out data from the writing restricted/protected recording unit and the protected recording unit.

11. The content-data distribution system according to claim 9, wherein
the server stores an MKB, and
the authentication unit of the server includes an MKB updating unit which updates the MKB and generates the first authentication key.

12. The content-data distribution system according to claim 11, wherein
the recording device comprises a communication control unit, and
the controller generates a session key in accordance with the first authentication key or the second authentication key, and
the communication control unit establishes a secured channel in accordance with the session key and processes a communication with the server.

13. The content-data distribution system according to claim 12, wherein the server comprises:
a medium-unique key processing unit configured to generate a medium-unique key in accordance with the MKB updating process; and
an encryption/decryption unit configured to encrypt a title key with the medium-unique key and encrypt the content data with the title key, and wherein
the server distributes the encrypted title key and the encrypted content data to the recording device through the secured channel.

14. The content-data distribution system according to claim 13, wherein the recording device records the encrypted title key distributed from the server in the writing restricted/protected recording unit, and records the encrypted content data in the normal recording unit.

15. A content-data distribution system comprising:
a recording/playback device configured to distribute encrypted first content data; and
a recording device configured to store the encrypted first content data and second content data distributed from an external device, and
the recording/playback device and the recording device each comprising authentication unit configured to execute a first authentication process,
the authentication unit of the recording device further executing a second authentication process,
the recording device comprising a memory unit configured to be communicationable with the recording/playback device and the external device through the first and second authentication processes, and to record key data for encryption of the first and the second content data, and a controller configured to control the memory unit,
the memory unit including a normal recording unit configured to be accessible from the recording/playback device and the external device through the controller without an authentication process, a protected recording unit configured to be accessible from the recording/playback device and the external device when authentication of the first authentication process completes, and a writing restricted/protected recording unit configured to be accessible from the external device when authentication of the second authentication process completes and to be unwritable and unaccessible from the recording/playback device and the external device when authentication of only the first authentication process completes.

16. The content-data distribution system according to claim 15, wherein
the first authentication process is executed with a first authentication key which is generated through an MKB authentication process, and
the second authentication process is executed with a second key which is generated by combining the first authentication key and a session key, the session key being generated through a PKI authentication process.

17. The content-data distribution system according to claim 16, wherein
the recording/playback device stores an MKB, and
the authentication unit of the recording/playback device includes an MKB updating unit which updates the MKB and generates the first authentication key.

18. The content-data distribution system according to claim 17, wherein
the recording device comprises a communication control unit, and
the controller establishes a secured channel in accordance with the first authentication key and processes a communication with the recording/playback device.

19. The content-data distribution system according to claim 18, wherein the recording/playback device comprises:
a medium-unique key processing unit configured to generate a medium-unique key in accordance with the MKB updating process; and
an encryption/decryption unit configured to encrypt a first title key with the medium-unique key, and encrypt the first content data with the first title key, and
the recording/playback device distributes the encrypted first title key and the encrypted first content data to the recording device through the secured channel.

20. The content-data distribution system according to claim 19, wherein the recording device records the encrypted first title key distributed from the recording/playback device in the protected recording unit, and records the encrypted first content data in the normal recording unit.
